(19) United States
(12) Patent Application Publication
(10) Pub. No.: US 2026/0029947 A1
(43) Pub. Date: Jan. 29, 2026

(54) CROSS TEMPERATURE COLLECTION AND REPORTING IN A MEMORY SYSTEM

(71) Applicant: Micron Technology, Inc., Boise, ID (US)

(72) Inventors: Dionisio Minopoli, Frattamaggiore (IT); Giuseppe Ferrari, Napoli (IT); Giuseppe D'Eliseo, Caserta (IT); Paolo Amato, Treviglio (IT); Antonino Pollio, Vico Equense (IT); Jonathan S. Parry, Boise, ID (US)

(21) Appl. No.: 19/270,081

(22) Filed: Jul. 15, 2025

Related U.S. Application Data
(60) Provisional application No. 63/674,917, filed on Jul. 24, 2024.

(51) Int. Cl. G06F 3/06

(52) U.S. Cl. CPC G06F 3/0653; G06F 3/0611; G06F 3/0659; G06F 3/0679

(57) ABSTRACT

Methods, systems, and devices for cross temperature collection and reporting in a memory system are described. A memory system may write, to a buffer in response to performing a read operation for a logical address, an indication of the logical address and a read temperature, for the logical address, of the memory system during the read operation. The memory system may determine, in response to detecting an idle time and using the read temperature from the buffer, a cross temperature for the logical address. The memory system may then transmit an indication of the cross temperature for the logical address after determining the cross temperature using the read temperature from the buffer.

### CROSS REFERENCE

The present Application for Patent claims priority to U.S. Patent Application No. 63/674,917 by Minopoli et al., entitled “CROSS TEMPERATURE COLLECTION AND REPORTING IN A MEMORY SYSTEM,” filed Jul. 24, 2024, which is assigned to the assignee hereof, and which is expressly incorporated by reference in its entirety herein.

### TECHNICAL FIELD

The following relates to one or more systems for memory, including cross temperature collection and reporting in a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not- or (NOR) and not- and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports cross temperature collection and reporting in a memory system in accordance with examples as disclosed herein.

FIG. 2 shows an example of a system that supports cross temperature collection and reporting in a memory system in accordance with examples as disclosed herein.

FIG. 3 shows an example of a process flow that supports cross temperature collection and reporting in a memory system in accordance with examples as disclosed herein.

FIG. 4 shows an example of a process flow that supports cross temperature collection and reporting in a memory system in accordance with examples as disclosed herein.

FIG. 5 shows a block diagram of a memory system that supports cross temperature collection and reporting in a memory system in accordance with examples as disclosed herein.

FIG. 6 shows a block diagram of a host system that supports cross temperature collection and reporting in a memory system in accordance with examples as disclosed herein.

FIGS. 7 and 8 show flowcharts illustrating a method or methods that support cross temperature collection and reporting in a memory system in accordance with examples as disclosed herein.

### DETAILED DESCRIPTION

A system that includes a host system and a memory system may experience extreme temperature conditions that vary from very cold (e.g., −40° C.) to very hot (e.g., 120° C.). To properly manage the memory system across various temperature conditions, it may be beneficial for the host system to have access to temperature information for the memory system. For example, it may be beneficial for the host system to have access to cross temperature information, where the cross temperature for a logical address refers to the difference between the write temperature for the logical address and a subsequent read temperature for the logical address. But collection of cross temperature information by the memory system during foreground operation (e.g., while the memory system is in the process of servicing host system commands) may increase the latency of the memory system in serving host system commands.

According to the techniques described herein, a memory system may collect and report cross temperature information without negatively impacting the latency of the memory system, among other advantages, by employing a tracking scheme that allows the memory system to determine cross temperature information during an idle time in which commands from the host system are paused. As part of the tracking scheme, the memory system may record one or more selected logical addresses (e.g., logical addresses selected in accordance with one or more metrics) targeted for read operations by the host system as well as the read temperatures for those logical address(es). During the idle time, the memory system may use the recorded information, in addition to write temperature information for the logical address(es), to determine cross temperature information for the recorded logical address(es). In some examples, the memory system may be prompted to perform the tracking scheme, and may be prompted to report the cross temperature information, by a host system. In some examples, the metrics for the tracking scheme may be indicated to the memory system by the host system.

In addition to applicability in memory systems as described herein, techniques for collecting cross temperature information may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by decreasing latency times and enabling temperature-based memory system management, among other benefits.

In addition to applicability in memory systems as described herein, techniques for collecting cross temperature information may be generally implemented to support increased connectivity of electronic systems. As the use of systems relying on interconnected electronic devices increases, the connectivity of these electronic devices becomes an increasingly relevant factor for the operations of the system. For example, delays associated with signals communicated between devices may become increasingly relevant as critical systems come to rely more on connectivity, as a system uses larger quantities of interconnected devices, or if the quantity and the complexity of signals communicated between devices increases. Implementing the techniques described herein may support techniques for increased connectivity in electronic systems by improving data transfer between devices, among other benefits.

Features of the disclosure are illustrated and described in the context of systems, devices, and circuits. Features of the disclosure are further illustrated and described in the context of process flows, device diagrams, and flowcharts.

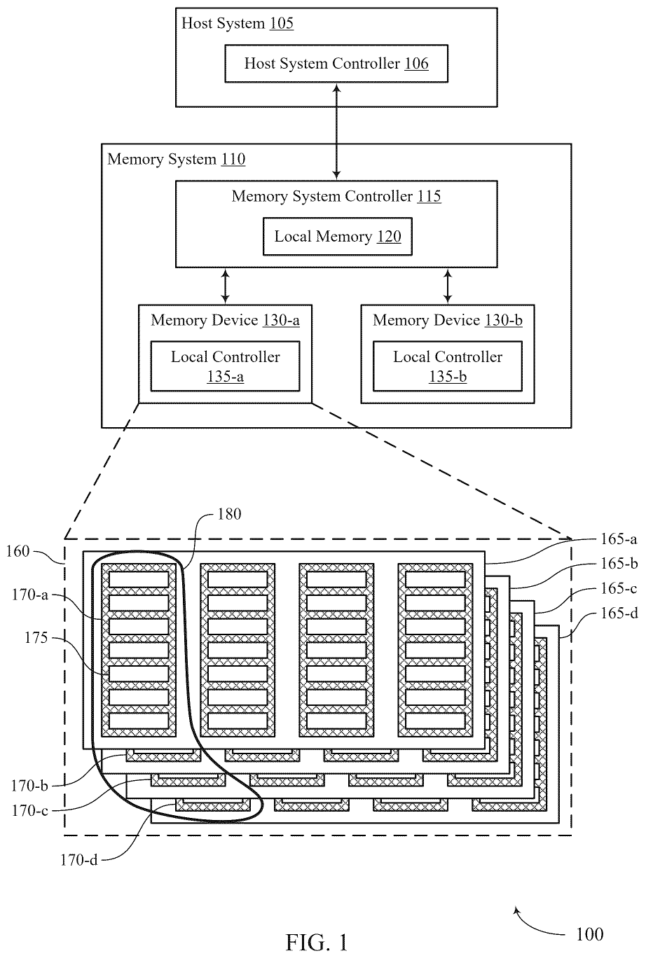

FIG. 1 shows an example of a system 100 that supports cross temperature collection and reporting in a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IOT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130-a mong other such operations-which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In some examples, the system 100 may be deployed (e.g., in a car) such that the system 100 is subjected to large variations in temperature. In such a scenario, it may be beneficial for the host system 105, the memory system 110, or both, to have access to cross temperature information for the memory system 110. For example, the host system 105 may use the cross temperature information to manage control of, and access to, the memory system 110. And the memory system 110 may use the cross temperature information to manage memory maintenance operations such as refresh operations in which content is copied from one set of memory cells to another set of memory cells.

The cross temperature for a logical address may be calculated as the difference between the write temperature for the logical address and the read temperature for the logical address, where the write temperature for the logical address is the temperature of the memory system during a write operation for the logical address, and where the read temperature for the logical address is the temperature of the memory system during a read operation for the logical address. So, collection of cross temperature information for logical addresses may involve use of both the write temperatures and the read temperatures for the logical addresses. But determining the write temperatures and the read temperatures for logical addresses during foreground operation may increase the latency of the memory system 110 in servicing access commands (e.g., read commands, write commands) from the host system 105.

According to the techniques described herein, the memory system 110 may use a tracking scheme (e.g., during foreground operation) to record information that allows the memory system 110 to determine cross temperature information at an idle time. For example, for select logical addresses, which may be selected by the memory system in accordance with one or more metrics provided by the host system 105, the memory system 110 may record both the logical addresses as well as the read temperatures for the logical addresses. The memory system 110 may record the logical addresses and the read temperatures in a buffer.

In response to detecting an idle time (e.g., a time at which access commands from the host system 105 are not pending for the memory system 110), the memory system 110 may reference the recorded logical addresses to read write temperatures for the logical addresses that is stored in the memory devices 130. The memory system 110 may then use the write temperatures and the recorded read temperatures to determine cross temperature information for the logical addresses. Cross temperature information may refer to one or more cross temperature values, one or more metrics or statistical values derived from (e.g., based on) the cross temperature values, or both. The memory system 110 store the cross temperature information (e.g., in one or more of the memory device(s) 130) so that the memory system 110 can (e.g., upon request from the host system 105) provide the cross temperature information to the host system 105.

The system 100 may include any quantity of non-transitory computer readable media that support cross temperature collection and reporting in a memory system. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

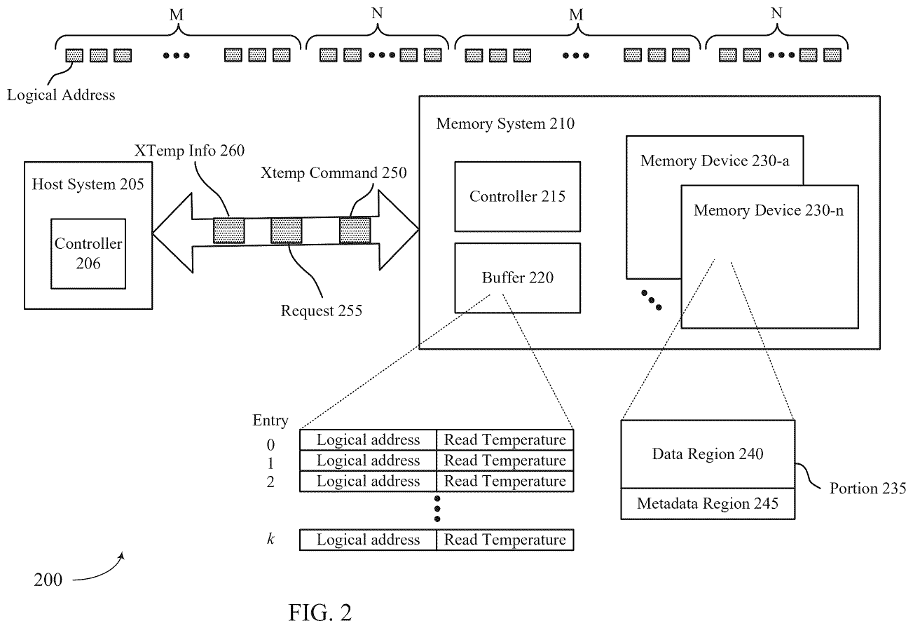

FIG. 2 shows an example of a system 200 that supports cross temperature collection and reporting in a memory system in accordance with examples as disclosed herein. The system 200 may be an example of a system 100 as described with reference to FIG. 1, or aspects thereof. The system 200 may include a memory system 210 configured to store data received from the host system 205 and to send data to the host system 205, if requested by the host system 205 using access commands (e.g., read commands or write commands). According to the techniques described herein, the memory system 210 may use a tracking scheme that allows the memory system 210 to collect cross temperature information during an idle time.

The system 200 may implement aspects of the system 100 as described with reference to FIG. 1. For example, the memory system 210 and the host system 205 may be examples of the memory system 110 and the host system 105, respectively. The host system 205 may include a controller 206, which may be implemented by one or more controllers and which may be an example of the host system controller 106. The memory system 210 may include a controller 215, which may be implemented by one or more controllers and which may be an example of the memory system controller 115.

The memory system 210 may include one or more memory devices 230 (e.g., memory device 230-a through memory device 230-n), which may be examples of the memory devices 130 as described with reference to FIG. 1. A memory device 230 may be divided into portions 235 (e.g., pages) and a portion 235 may include A) a data region 240 (or “sub-portion”) for storing data and B) a metadata region 245 (or “sub-portion”) for storing metadata associated with the data. For example, the metadata region 245 for a portion may store one or more write temperatures for the logical address(es) associated with the portion 235.

The memory system 210 may also include a buffer 220, which the memory system 210 may use to record information that enables collection of cross temperature information. In some examples, the buffer 220 may be a fixed-size buffer (e.g., with k entries). For instance, the buffer 220 may be a circular buffer that overwrites the oldest entry with new information if the buffer is full. In some examples, the buffer may be a volatile memory. In some examples, the buffer 220 may be an example of the local memory 120.

During foreground operation, the memory system 210 may implement a tracking scheme that enables collection of cross temperature information during an idle time. In some example, the memory system 210 may implement the tracking scheme in response to a command (e.g., the XTemp Command 250) received from the host system 205. In some examples, the XTemp Command 250 may be a vendor unique (VU) command.

As part of the tracking scheme, the memory system 210 may record (e.g., write to the buffer 220) select logical addresses and the corresponding read temperatures for those logical addresses. The memory system 210 may select the logical addresses in accordance with one or more metrics. For example, for every M (e.g., 100,000) logical addresses targeted for reading by the host system 205, the memory system 210 may select the next N (e.g., 100) logical addresses for recordation, where M and N are each a positive integer. Thus, information for N logical addresses may be recorded for every M+N logical addresses targeted for reading by the host system 205. Recording information for select logical addresses (as opposed to for every logical address targeted for reading) may reduce the overhead associated with collecting the cross temperature information.

The memory system 210 may write the N logical addresses to the buffer 220 along with the read temperatures for the N logical addresses. Recording the read temperatures may allow the memory system 210 to accurately calculate the cross temperature information for the logical addresses even though the memory system 210 does not calculate the cross temperature information until a later time (e.g., after the temperature of the memory system 210 may have changed). Recording the logical addresses may allow the memory system 210 to use the correct write temperatures for calculating the cross temperature information.

In some examples, the metrics (e.g., M, N) may be indicated by the XTemp Command 250. In other examples, one or both of the metrics (e.g., M, N) may be autonomously determined (e.g., determined independent of the host system 205) by the memory system 210. For example, M may be randomly determined by the memory system 210, N may be randomly determined by the memory system 210, or both, providing that N is less than M. In some examples, the value of M may change. For example, M=M1 may be used to record information for N logical addresses, and M=M2 may be used to record information for the next N logical addresses. In some examples, N, M, or both may have a default value (e.g., M=100,000, N=1). If N has a default value, M may be indicated by the XTemp Command 250 or autonomously determined by the memory system 210. If M has a default value, N may be indicated by the XTemp Command 250 or autonomously determined by the memory system 210. If both N and M have default values, the default values may be fixed or changeable.

In some examples, the host system 205 may select one or both of the metrics (e.g., M, N) in accordance with a size of the buffer 220. In such examples, the memory system 210 may transmit an indication of the size of the buffer 220 to the host system 205 and the host system 205 may use the size as a basis for selecting one or both of the metrics.

In response to detecting an idle time, the memory system 210 may use the information recorded in the buffer 220 to calculate cross temperature information for the logical addresses recorded in the buffer 220. In some examples, the memory system 210 may detect the idle time by determining that a command queue for access commands from the host system 205 is empty.

To calculate cross temperature information for the logical addresses recorded in the buffer 220, the memory system 210 may read the write temperatures for the logical addresses from the memory device(s) 230. Thus, the memory system 210 may generate internal read commands for the portions 235 (e.g., for the metadata regions 245) associated with the recorded logical addresses. Because the read commands are internally generated (as opposed to being received from the host system 205), the memory system 210 may refrain from returning the content read from the portions 235.

For a given logical address, the memory system 210 may use the write temperature (e.g., read from the memory device 230) and the read temperature (e.g., read from the buffer 220) to determine the cross temperature information for that logical address. For example, the memory system may calculate the cross temperature for the logical address as the difference between the write temperature for the logical address and the read temperature for the logical address. The memory system 210 may write the cross temperature information for the recorded logical addresses in the buffer 220, in the memory device(s) 230, or both. Writing the cross temperature information to the memory device(s) 230 may ensure preservation of the cross temperature information in the event of a power loss, whereas writing the cross temperature information to the buffer 220 may reduce the latency of responding to a request for the cross temperature information. In some examples, the memory system 210 may use the cross temperature information to manage refresh operations of the memory system 210.

The host system 205 may request the temperature information by transmitting a request 255 to the memory system 210. The request 255 may specifically request the cross temperature information (e.g., the request 255 may be a VU command dedicated to collection of cross temperature information) or the request 255 may request the cross temperature information in addition to requesting other status information for the memory system 210 (e.g., the request 255 may be a device health report request). In response to the request 255, the memory system 210 may read the cross temperature information (e.g., from the buffer 220, from memory device(s) 230) and transmit the cross temperature information (e.g., as XTemp Info 260) to the host system 205. The host system 205 may then use the cross temperature information to manage the memory system 210.

Thus, the memory system 210 may use a tracking scheme that allows the memory system 210 to collect cross temperature information during an idle time, which may improve the latency of the memory system 210 compared to other techniques.

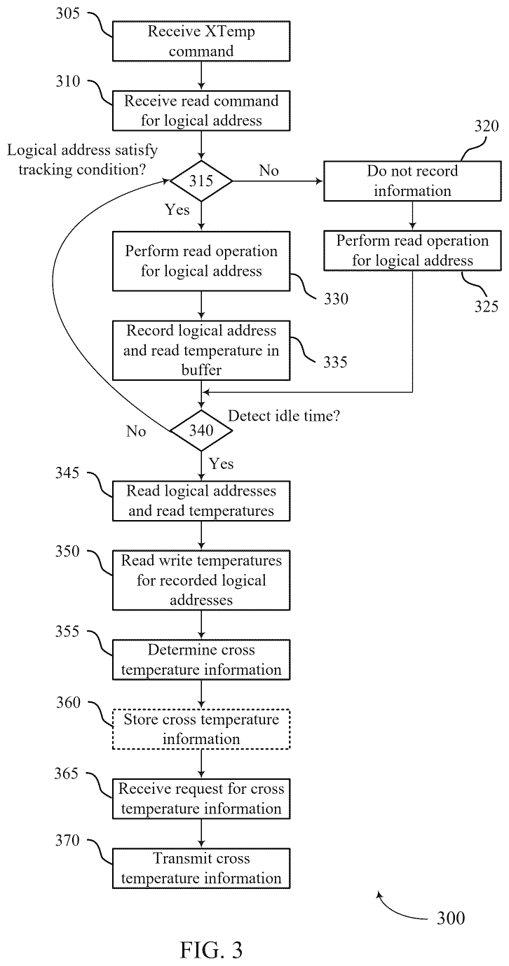

FIG. 3 shows an example of a process flow 300 that supports cross temperature collection and reporting in a memory system in accordance with examples as disclosed herein. The process flow 300 may be implemented by a memory system (e.g., a memory system 110, a memory system 210) as described herein. The process flow 300 may allow the memory system to collect cross temperature information during an idle time detected by the memory system.

Aspects of the process flow 300 may be implemented by one or more controllers, among other components. Additionally, or alternatively, aspects of the process flow 300 may be implemented as instructions stored in one or more memories (e.g., firmware stored in one or more memories coupled with the memory system 110 or the memory system 210). For example, the instructions, if executed by one or more controllers (e.g., the memory system controller 115, a local controller 135, the controller 215), may cause the one or more controllers (or a device or a system) to perform the operations of the process flow 300.

At 305, a command (e.g., an XTemp command) for collection of cross temperature information may be received (e.g., by a memory system). The command may be received from a host system and may indicate one or more metrics the memory system is to use for collecting the cross temperature information. For example, the command may indicate M, N, or both, where M is the quantity of logical addresses that should be targeted for reading before the memory system records information for N logical addresses also targeted for reading. Alternatively, the memory system may determine one or more of the metrics (e.g., M, N, or both) autonomously.

In some examples, the host system may select one or both of the metrics (e.g., M, N) in accordance with a size of the buffer used by the memory system for the tracking scheme. In such examples, the memory system may transmit an indication of the size of the buffer to the host system and the host system may use the size as a basis for selecting one or both of the metrics.

At 310, a read command for a logical address may be received (e.g., by the memory system). At 315, it may be determined (e.g., by the memory system) whether the logical address targeted for reading satisfies one or more tracking conditions. For example, the memory system may determine whether the logical address is one of the N logical addresses targeted for reading since receipt of a set of M logical addresses for reading, where the set of M logical addresses are counted relative to the last-recorded logical address.

If, at 315, it is determined that the logical address does not satisfy the one or more tracking conditions, the process flow 300 may proceed to 320. At 320, the memory system may refrain from recording the logical address and read temperature in the buffer. At 325, a read operation may be performed for the logical address and content read for the logical address may be returned to the host system.

If, at 315, it is determined that the logical address satisfies the one or more tracking conditions, the process flow 300 may proceed to 330. At 330, a read operation may be performed for the logical address (and content read for the logical address may be returned to the host system). The read temperature for the logical address may also be determined. At 335, the logical address and the read temperature for the logical address may be recorded in (e.g., written to) a buffer of the memory system.

At 340, it may be determined (e.g., by the memory system) whether an idle time has been detected. For example, the memory system may detect the idle time by determining that a queue for access commands from the host system is empty or has been empty for a threshold duration. If, at 340, it is determined that an idle time has not been detected, the process flow 300 may proceed to 315.

If, at 340, it is determined that an idle time has been detected, the process flow 300 may proceed to 345. At 345, the logical addresses and read temperatures recorded in the buffer may be read (e.g., by the memory system). At 350, the write temperatures for the logical addresses may be read (e.g., by the memory system). For example, for a recorded logical address the memory system may read a portion 235 of memory associated with the logical address to obtain the write temperature for the logical address. The memory system may read the portion 235 in response to an internal read command generated by the memory system independent of the host system. Accordingly, the memory system may refrain from communicating content read from the portion 235 to the host system.

At 355, cross temperature information for the recorded logical addresses may be determined (e.g., by the memory system). For example, the memory system may use the read temperature and the write temperature for a recorded logical address to calculate the cross temperature for that logical address. In some examples, the cross temperatures determined at 355 may be used to determine statistical cross temperature information for the memory system. For example, the cross temperatures may be used to dynamically build a historical histogram or other metric of the cross temperatures collected for a duration of time. At 360, the cross temperature information (e.g., one or more cross temperatures, one or more metrics derived from or based on the cross temperatures) determined at 355 may be stored (e.g., in the buffer 220, in another buffer of the memory system, in one or more of the memory device(s) 230).

At 365, a request for the cross temperature information may be received (e.g., by the memory system). The request may be received from the host system after expiration of the idle time. At 370, the cross temperature information (e.g., one or more cross temperatures, one or more metrics derived from or based on the cross temperatures) may be transmitted to the host system in response to the request. The cross temperature information may be transmitted after reading the cross temperature information from storage.

Thus, the memory system to collect cross temperature information during an idle time detected by the memory system, which may improve the performance of the memory system relative to other collection techniques. Alternative examples of the foregoing may be implemented, where some operations are performed in a different order than described, are performed in parallel, or are not performed at all. In some cases, operations may include additional features not mentioned herein, or further operations may be added. Additionally, certain operations may be performed multiple times or certain combinations of operations may repeat or cycle.

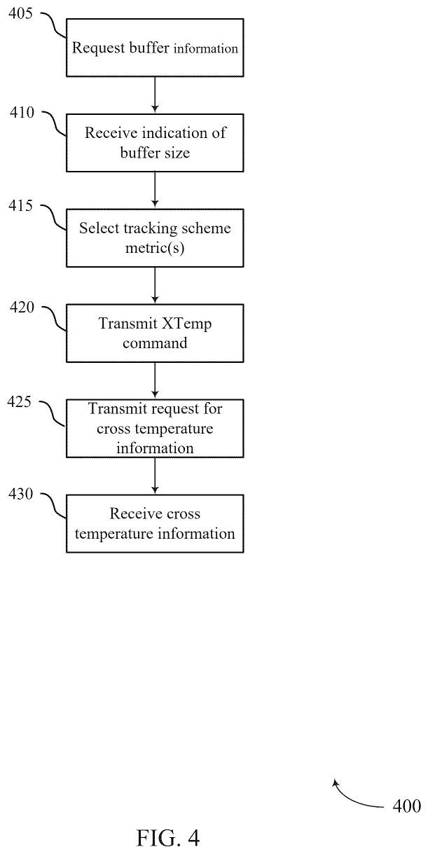

FIG. 4 shows an example of a process flow 400 that supports cross temperature collection and reporting in a memory system in accordance with examples as disclosed herein. The process flow 400 may be implemented by a host system (e.g., a host system 105, a host system 205) as described herein. The process flow 400 may allow the host system to obtain cross temperature information from a memory system without loss of performance by the memory system.

Aspects of the process flow 400 may be implemented by one or more controllers, among other components. Additionally, or alternatively, aspects of the process flow 400 may be implemented as instructions stored in one or more memories (e.g., firmware stored in one or more memories coupled with the host system 150 or the host system 205). For example, the instructions, if executed by one or more controllers (e.g., the host system controller 106, the controller 206), may cause the one or more controllers (or a device or a system) to perform the operations of the process flow 400.

At 405, a request for buffer information may be transmitted (e.g., by the host system). The request may be transmitted to the memory system. In some examples, the request may be transmitted in response to the host system determining to transmit an XTempt command for cross temperature information. At 410, an indication of a size of the buffer may be received (e.g., by the host system). The indication maybe received from the memory system in response to the request at 405. At 415, one or more metrics for collecting cross temperature information may be selected in accordance with the size of the buffer. For example, the host system may use the size of the buffer as a basis for selecting M, N, or both.

At 420, a command (e.g., an XTemp command) for collection of cross temperature information may be transmitted (e.g., by the host system). The command may be transmitted to the memory system and may indicate the one or more metrics the memory system is to use for collecting the cross temperature information. For example, the command may indicate M, N, or both, where M is the quantity of logical addresses that should be targeted for reading before the memory system records information for N logical addresses also targeted for reading.

At 425, a request for the cross temperature information may be transmitted (e.g., by the host system). The request may be transmitted to the memory system. At 430, the cross temperature information may be received (e.g., by the host system) in response to the request.

The host system may use the cross temperature information to manage interactions with the memory system.

Thus, the host system to obtain cross temperature information from a memory system without loss of performance by the memory system. Alternative examples of the foregoing may be implemented, where some operations are performed in a different order than described, are performed in parallel, or are not performed at all. In some cases, operations may include additional features not mentioned herein, or further operations may be added. Additionally, certain operations may be performed multiple times or certain combinations of operations may repeat or cycle.

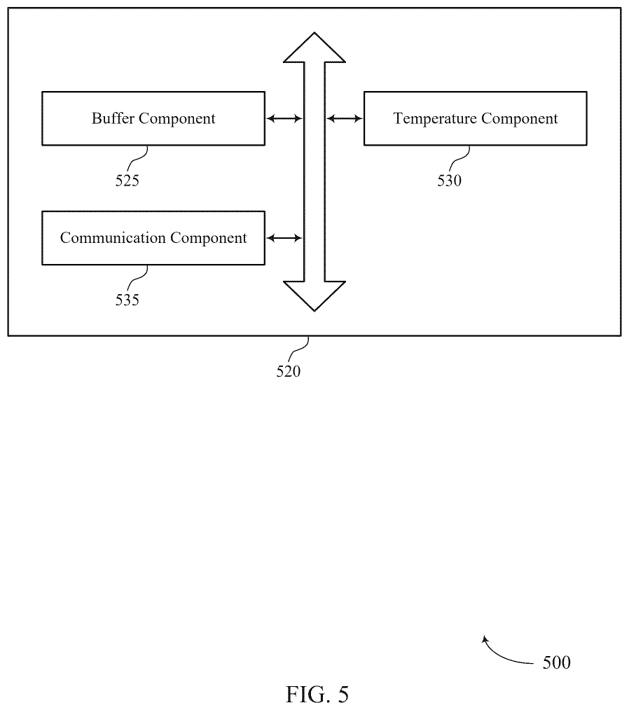

FIG. 5 shows a block diagram 500 of a memory system 520 that supports cross temperature collection and reporting in a memory system in accordance with examples as disclosed herein. The memory system 520 may be an example of aspects of a memory system as described with reference to FIGS. 1 through 4. The memory system 520, or various components thereof, may be an example of means for performing various aspects of cross temperature collection and reporting in a memory system as described herein. For example, the memory system 520 may include a buffer component 525, a temperature component 530, a communication component 535, or any combination thereof. Each of these components, or components of subcomponents thereof (e.g., one or more processors, one or more memories), may communicate, directly or indirectly, with one another (e.g., via one or more buses).

The buffer component 525 may be configured as or otherwise support a means for writing, to a buffer of a memory system in response to performing a read operation for a logical address, an indication of the logical address and a read temperature, for the logical address, of the memory system during the read operation. The temperature component 530 may be configured as or otherwise support a means for determining, in response to detecting an empty command queue for a host system and using the read temperature from the buffer, a cross temperature for the logical address, the cross temperature representative of a difference between the read temperature and a write temperature of the memory system during a write operation for the logical address. The communication component 535 may be configured as or otherwise support a means for transmitting an indication of the cross temperature for the logical address after determining the cross temperature using the read temperature from the buffer.

In some examples, the communication component 535 may be configured as or otherwise support a means for receiving a command for the memory system to collect cross temperature information for logical addresses, where the indication of the logical address and the read temperature are written to the buffer in response to receiving the command.

In some examples, the logical address and the read temperature are written to the buffer after a second logical address and a second read temperature for the second logical address are written to the buffer, and the temperature component 530 may be configured as or otherwise support a means for determining the read temperature for the logical address in response to determining that a threshold quantity of logical addresses have been targeted for reading since receipt of a read command for the second logical address.

In some examples, the communication component 535 may be configured as or otherwise support a means for transmitting an indication of a size of the buffer. In some examples, the communication component 535 may be configured as or otherwise support a means for receiving an indication of the threshold quantity in response to transmitting an indication of the size of the buffer.

In some examples, the threshold quantity is randomly generated by the memory system.

In some examples, the logical address is included in a set of logical addresses selected for writing to the buffer. In some examples, a respective read temperature for each logical address in the set of logical addresses is written to the buffer.

In some examples, the communication component 535 may be configured as or otherwise support a means for receiving an indication of a quantity of logical addresses for which temperature information is to be collected, where the set of logical addresses is selected in accordance with the quantity.

In some examples, the communication component 535 may be configured as or otherwise support a means for transmitting an indication of a size of the buffer, where the indication of the quantity of logical addresses in received in response to transmitting an indication of the size of the buffer.

In some examples, the temperature component 530 may be configured as or otherwise support a means for reading the write temperature for the logical address from a non-volatile memory in response to detecting the empty command queue, where the cross temperature is determined using the write temperature.

In some examples, the temperature component 530 may be configured as or otherwise support a means for storing the cross temperature in a non-volatile memory of the memory system in response to determining the cross temperature. In some examples, the temperature component 530 may be configured as or otherwise support a means for reading the cross temperature from the non-volatile memory in response to a message requesting the cross temperature, where the cross temperature is transmitted after reading the cross temperature from the non-volatile memory.

In some examples, the communication component 535 may be configured as or otherwise support a means for triggering a refresh operation for a set of memory cells associated with the logical address in accordance with the cross temperature for the logical address.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

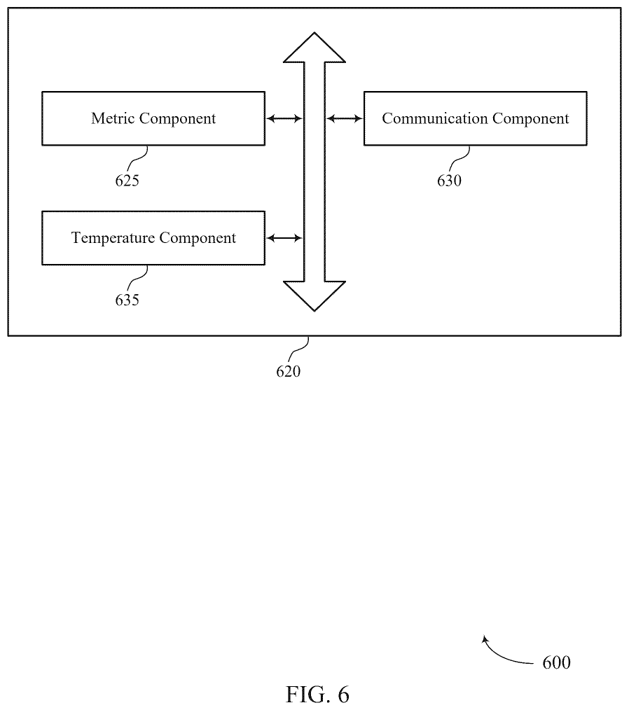

FIG. 6 shows a block diagram 600 of a host system 620 that supports cross temperature collection and reporting in a memory system in accordance with examples as disclosed herein. The host system 620 may be an example of aspects of a host system as described with reference to FIGS. 1 through 4. The host system 620, or various components thereof, may be an example of means for performing various aspects of cross temperature collection and reporting in a memory system as described herein. For example, the host system 620 may include a metric component 625, a communication component 630, a temperature component 635, or any combination thereof. Each of these components, or components of subcomponents thereof (e.g., one or more processors, one or more memories), may communicate, directly or indirectly, with one another (e.g., via one or more buses).

The metric component 625 may be configured as or otherwise support a means for selecting a metric for a memory system to use in collecting cross temperature information for logical addresses, where the cross temperature information for a logical address represents a difference between a read temperature of the memory system during a read operation for the logical address and a write temperature of the memory system during a write operation for the logical address. The communication component 630 may be configured as or otherwise support a means for transmitting a command for the memory system to collect the cross temperature information for logical addresses in accordance with the metric, where the command indicates the metric. In some examples, the communication component 630 may be configured as or otherwise support a means for transmitting, in response to transmitting the command, a message requesting the cross temperature information collected by the memory system in accordance with the metric. The temperature component 635 may be configured as or otherwise support a means for receiving, in response to transmitting the message, the cross temperature information collected by the memory system in accordance with the metric.

In some examples, the communication component 630 may be configured as or otherwise support a means for receiving an indication of a size of a buffer used by the memory system to collect the cross temperature information, where the metric is selected in accordance with the size of the buffer.

In some examples, the metric includes a quantity of logical addresses. In some examples, the command is for the memory system to collect cross temperature information for at least one logical address for each set of logical addresses that is targeted for reading and that includes the quantity.

In some examples, the metric component 625 may be configured as or otherwise support a means for determining a second metric for the memory system to use in collecting cross temperature information for logical addresses, where the command indicates the second metric.

In some examples, the second metric includes a quantity of logical addresses for which the memory system is to collect cross temperature information on a periodic basis.

In some examples, the communication component 630 may be configured as or otherwise support a means for receiving an indication of a size of a buffer used by the memory system to collect the cross temperature information, where the second metric is selected in accordance with the size of the buffer and in accordance with the metric.

In some examples, the described functionality of the host system 620, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the host system 620, or various components thereof, may be implemented at least in part by instructions (e.g., stored in memory, non-transitory computer-readable medium) executable by such at least one processor.

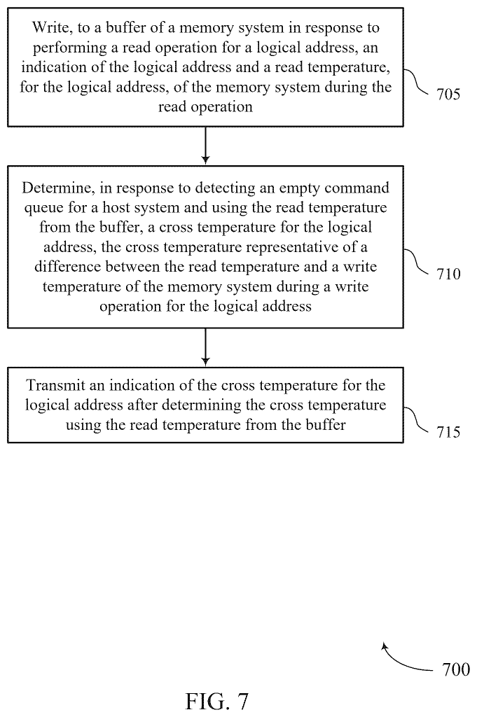

FIG. 7 shows a flowchart illustrating a method 700 that supports cross temperature collection and reporting in a memory system in accordance with examples as disclosed herein. The operations of method 700 may be implemented by a memory system or its components as described herein. For example, the operations of method 700 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 705, the method may include writing, to a buffer of a memory system in response to performing a read operation for a logical address, an indication of the logical address and a read temperature, for the logical address, of the memory system during the read operation. In some examples, aspects of the operations of 705 may be performed by a buffer component 525 as described with reference to FIG. 5.

At 710, the method may include determining, in response to detecting an empty command queue for a host system and using the read temperature from the buffer, a cross temperature for the logical address, the cross temperature representative of a difference between the read temperature and a write temperature of the memory system during a write operation for the logical address. In some examples, aspects of the operations of 710 may be performed by a temperature component 530 as described with reference to FIG. 5.

At 715, the method may include transmitting an indication of the cross temperature for the logical address after determining the cross temperature using the read temperature from the buffer. In some examples, aspects of the operations of 715 may be performed by a communication component 535 as described with reference to FIG. 5.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for writing, to a buffer of a memory system in response to performing a read operation for a logical address, an indication of the logical address and a read temperature, for the logical address, of the memory system during the read operation; determining, in response to detecting an empty command queue for a host system and using the read temperature from the buffer, a cross temperature for the logical address, the cross temperature representative of a difference between the read temperature and a write temperature of the memory system during a write operation for the logical address; and transmitting an indication of the cross temperature for the logical address after determining the cross temperature using the read temperature from the buffer.
Aspect 2: The method, apparatus, or non-transitory computer-readable medium of aspect 1, further including operations, features, circuitry, logic, means, or instructions, or any combination thereof for receiving a command for the memory system to collect cross temperature information for logical addresses, where the indication of the logical address and the read temperature are written to the buffer in response to receiving the command.
Aspect 3: The method, apparatus, or non-transitory computer-readable medium of any of aspects 1 through 2, where the logical address and the read temperature are written to the buffer after a second logical address and a second read temperature for the second logical address are written to the buffer and the method, apparatuses, and non-transitory computer-readable medium further includes operations, features, circuitry, logic, means, or instructions, or any combination thereof for determining the read temperature for the logical address in response to determining that a threshold quantity of logical addresses have been targeted for reading since receipt of a read command for the second logical address.
Aspect 4: The method, apparatus, or non-transitory computer-readable medium of aspect 3, further including operations, features, circuitry, logic, means, or instructions, or any combination thereof for transmitting an indication of a size of the buffer and receiving an indication of the threshold quantity in response to transmitting an indication of the size of the buffer.
Aspect 5: The method, apparatus, or non-transitory computer-readable medium of any of aspects 3 through 4, where the threshold quantity is randomly generated by the memory system.
Aspect 6: The method, apparatus, or non-transitory computer-readable medium of any of aspects 1 through 5, where the logical address is included in a set of logical addresses selected for writing to the buffer and a respective read temperature for each logical address in the set of logical addresses is written to the buffer.
Aspect 7: The method, apparatus, or non-transitory computer-readable medium of aspect 6, further including operations, features, circuitry, logic, means, or instructions, or any combination thereof for receiving an indication of a quantity of logical addresses for which temperature information is to be collected, where the set of logical addresses is selected in accordance with the quantity.
Aspect 8: The method, apparatus, or non-transitory computer-readable medium of aspect 7, further including operations, features, circuitry, logic, means, or instructions, or any combination thereof for transmitting an indication of a size of the buffer, where the indication of the quantity of logical addresses in received in response to transmitting an indication of the size of the buffer.
Aspect 9: The method, apparatus, or non-transitory computer-readable medium of any of aspects 1 through 8, further including operations, features, circuitry, logic, means, or instructions, or any combination thereof for reading the write temperature for the logical address from a non-volatile memory in response to detecting the empty command queue, where the cross temperature is determined using the write temperature.
Aspect 10: The method, apparatus, or non-transitory computer-readable medium of any of aspects 1 through 9, further including operations, features, circuitry, logic, means, or instructions, or any combination thereof for storing the cross temperature in a non-volatile memory of the memory system in response to determining the cross temperature and reading the cross temperature from the non-volatile memory in response to a message requesting the cross temperature, where the cross temperature is transmitted after reading the cross temperature from the non-volatile memory.
Aspect 11: The method, apparatus, or non-transitory computer-readable medium of any of aspects 1 through 10, further including operations, features, circuitry, logic, means, or instructions, or any combination thereof for triggering a refresh operation for a set of memory cells associated with the logical address in accordance with the cross temperature for the logical address.

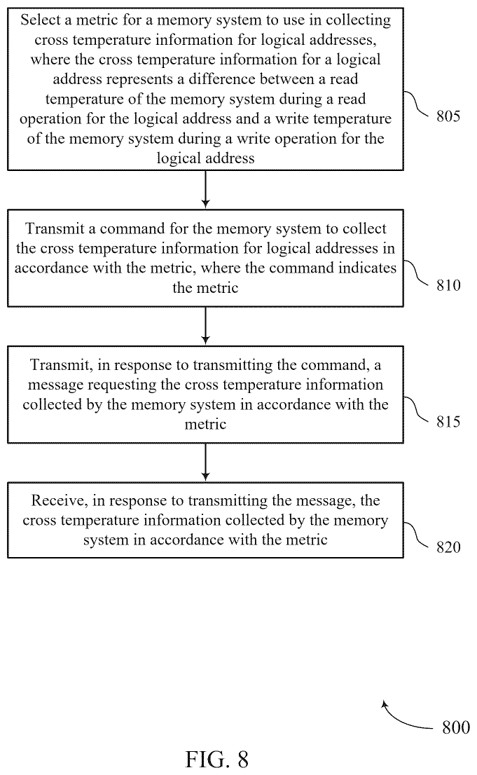

FIG. 8 shows a flowchart illustrating a method 800 that supports cross temperature collection and reporting in a memory system in accordance with examples as disclosed herein. The operations of method 800 may be implemented by a host system or its components as described herein. For example, the operations of method 800 may be performed by a host system as described with reference to FIGS. 1 through 4 and 6. In some examples, a host system may execute a set of instructions to control the functional elements of the device to perform the described functions. Additionally, or alternatively, the host system may perform aspects of the described functions using special-purpose hardware.

At 805, the method may include selecting a metric for a memory system to use in collecting cross temperature information for logical addresses, where the cross temperature information for a logical address represents a difference between a read temperature of the memory system during a read operation for the logical address and a write temperature of the memory system during a write operation for the logical address. In some examples, aspects of the operations of 805 may be performed by a metric component 625 as described with reference to FIG. 6.

At 810, the method may include transmitting a command for the memory system to collect the cross temperature information for logical addresses in accordance with the metric, where the command indicates the metric. In some examples, aspects of the operations of 810 may be performed by a communication component 630 as described with reference to FIG. 6.

At 815, the method may include transmitting, in response to transmitting the command, a message requesting the cross temperature information collected by the memory system in accordance with the metric. In some examples, aspects of the operations of 815 may be performed by a communication component 630 as described with reference to FIG. 6.

At 820, the method may include receiving, in response to transmitting the message, the cross temperature information collected by the memory system in accordance with the metric. In some examples, aspects of the operations of 820 may be performed by a temperature component 635 as described with reference to FIG. 6.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:
Aspect 12: A method, apparatus, or non-transitory computer-readable medium including operations, features, circuitry, logic, means, or instructions, or any combination thereof for selecting a metric for a memory system to use in collecting cross temperature information for logical addresses, where the cross temperature information for a logical address represents a difference between a read temperature of the memory system during a read operation for the logical address and a write temperature of the memory system during a write operation for the logical address; transmitting a command for the memory system to collect the cross temperature information for logical addresses in accordance with the metric, where the command indicates the metric; transmitting, in response to transmitting the command, a message requesting the cross temperature information collected by the memory system in accordance with the metric; and receiving, in response to transmitting the message, the cross temperature information collected by the memory system in accordance with the metric.
Aspect 13: The method, apparatus, or non-transitory computer-readable medium of aspect 12, further including operations, features, circuitry, logic, means, or instructions, or any combination thereof for receiving an indication of a size of a buffer used by the memory system to collect the cross temperature information, where the metric is selected in accordance with the size of the buffer.
Aspect 14: The method, apparatus, or non-transitory computer-readable medium of any of aspects 12 through 13, where the metric includes a quantity of logical addresses and the command is for the memory system to collect cross temperature information for at least one logical address for each set of logical addresses that is targeted for reading and that includes the quantity.
Aspect 15: The method, apparatus, or non-transitory computer-readable medium of any of aspects 12 through 14, further including operations, features, circuitry, logic, means, or instructions, or any combination thereof for determining a second metric for the memory system to use in collecting cross temperature information for logical addresses, where the command indicates the second metric.
Aspect 16: The method, apparatus, or non-transitory computer-readable medium of aspect 15, where the second metric includes a quantity of logical addresses for which the memory system is to collect cross temperature information on a periodic basis.
Aspect 17: The method, apparatus, or non-transitory computer-readable medium of any of aspects 15 through 16, further including operations, features, circuitry, logic, means, or instructions, or any combination thereof for receiving an indication of a size of a buffer used by the memory system to collect the cross temperature information, where the second metric is selected in accordance with the size of the buffer and in accordance with the metric.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

As used herein, the term “substantially” means that the modified characteristic (e.g., a verb or adjective modified by the term substantially) need not be absolute but is close enough to achieve the advantages of the characteristic.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
write, to a buffer of the memory system in response to performing a read operation for a logical address, an indication of the logical address and a read temperature, for the logical address, of the memory system during the read operation;
determine, in response to detecting an empty command queue for a host system and using the read temperature from the buffer, a cross temperature for the logical address, the cross temperature representative of a difference between the read temperature and a write temperature of the memory system during a write operation for the logical address; and
transmit an indication of the cross temperature for the logical address after determining the cross temperature using the read temperature from the buffer.

2. The memory system of claim 1, wherein the processing circuitry is further configured to cause the memory system to:
receive a command for the memory system to collect cross temperature information for logical addresses, wherein the indication of the logical address and the read temperature are written to the buffer in response to receiving the command.

3. The memory system of claim 1, wherein the logical address and the read temperature are written to the buffer after a second logical address and a second read temperature for the second logical address are written to the buffer, and wherein the processing circuitry is further configured to cause the memory system to:
determine the read temperature for the logical address in response to determining that a threshold quantity of logical addresses have been targeted for reading since receipt of a read command for the second logical address.

4. The memory system of claim 3, wherein the processing circuitry is further configured to cause the memory system to:
transmit an indication of a size of the buffer; and
receive an indication of the threshold quantity in response to transmitting an indication of the size of the buffer.

5. The memory system of claim 3, wherein the threshold quantity is randomly generated by the memory system.

6. The memory system of claim 1, wherein the logical address is included in a set of logical addresses selected for writing to the buffer, and wherein a respective read temperature for each logical address in the set of logical addresses is written to the buffer.

7. The memory system of claim 6, wherein the processing circuitry is further configured to cause the memory system to:
receive an indication of a quantity of logical addresses for which temperature information is to be collected, wherein the set of logical addresses is selected in accordance with the quantity.

8. The memory system of claim 7, wherein the processing circuitry is further configured to cause the memory system to:
transmit an indication of a size of the buffer, wherein the indication of the quantity of logical addresses in received in response to transmitting an indication of the size of the buffer.

9. The memory system of claim 1, wherein the processing circuitry is further configured to cause the memory system to:
read the write temperature for the logical address from a non-volatile memory in response to detecting the empty command queue, wherein the cross temperature is determined using the write temperature.

10. The memory system of claim 1, wherein the processing circuitry is further configured to cause the memory system to:
store the cross temperature in a non-volatile memory of the memory system in response to determining the cross temperature; and
read the cross temperature from the non-volatile memory in response to a message requesting the cross temperature, wherein the cross temperature is transmitted after reading the cross temperature from the non-volatile memory.

11. The memory system of claim 1, wherein the processing circuitry is further configured to cause the memory system to:
trigger a refresh operation for a set of memory cells associated with the logical address in accordance with the cross temperature for the logical address.

12. A host system, comprising:
one or more interfaces comprising one or more signal paths operable for communication with one or more memory systems; and
processing circuitry coupled with the one or more interfaces and configured to cause the host system to:
select a metric for a memory system of the one or more memory systems to use in collecting cross temperature information for logical addresses, wherein the cross temperature information for a logical address represents a difference between a read temperature of the memory system during a read operation for the logical address and a write temperature of the memory system during a write operation for the logical address;
transmit a command for the memory system to collect the cross temperature information for logical addresses in accordance with the metric, wherein the command indicates the metric;
transmit, in response to transmitting the command, a message requesting the cross temperature information collected by the memory system in accordance with the metric; and
receive, in response to transmitting the message, the cross temperature information collected by the memory system in accordance with the metric.

13. The host system of claim 12, wherein the processing circuitry is further configured to cause the host system to:
receive an indication of a size of a buffer used by the memory system to collect the cross temperature information, wherein the metric is selected in accordance with the size of the buffer.

14. The host system of claim 12, wherein the metric comprises a quantity of logical addresses, and wherein the command is for the memory system to collect cross temperature information for at least one logical address for each set of logical addresses that is targeted for reading and that comprises the quantity.

15. The host system of claim 12, wherein the processing circuitry is further configured to cause the host system to:
determine a second metric for the memory system to use in collecting cross temperature information for logical addresses, wherein the command indicates the second metric.

16. The host system of claim 15, wherein the second metric comprises a quantity of logical addresses for which the memory system is to collect cross temperature information on a periodic basis.

17. The host system of claim 15, wherein the processing circuitry is further configured to cause the host system to:
receive an indication of a size of a buffer used by the memory system to collect the cross temperature information, wherein the second metric is selected in accordance with the size of the buffer and in accordance with the metric.

18. A method, comprising:
writing, to a buffer of a memory system in response to performing a read operation for a logical address, an indication of the logical address and a read temperature, for the logical address, of the memory system during the read operation;
determining, in response to detecting an empty command queue for a host system and using the read temperature from the buffer, a cross temperature for the logical address, the cross temperature representative of a difference between the read temperature and a write temperature of the memory system during a write operation for the logical address; and
transmitting an indication of the cross temperature for the logical address after determining the cross temperature using the read temperature from the buffer.

19. The method of claim 18, further comprising:
receiving a command for the memory system to collect cross temperature information for logical addresses, wherein the indication of the logical address and the read temperature are written to the buffer in response to receiving the command.

20. The method of claim 18, wherein the logical address and the read temperature are written to the buffer after a second logical address and a second read temperature for the second logical address are written to the buffer, the method further comprising:
determining the read temperature for the logical address in response to determining that a threshold quantity of logical addresses have been targeted for reading since receipt of a read command for the second logical address.

21. The method of claim 20, further comprising:
transmitting an indication of a size of the buffer; and
receiving an indication of the threshold quantity in response to transmitting an indication of the size of the buffer.

22. The method of claim 18, wherein the logical address is included in a set of logical addresses selected for writing to the buffer, and wherein a respective read temperature for each logical address in the set of logical addresses is written to the buffer.

23. The method of claim 22, further comprising:
transmitting an indication of a size of the buffer; and
receiving, in response to transmitting an indication of the size of the buffer, an indication of a quantity of logical addresses for which temperature information is to be collected, wherein the set of logical addresses is selected in accordance with the quantity.

24. The method of claim 18, further comprising:
reading the write temperature for the logical address from a non-volatile memory in response to detecting the empty command queue, wherein the cross temperature is determined using the write temperature.

25. The method of claim 18, further comprising:
storing the cross temperature in a non-volatile memory of the memory system in response to determining the cross temperature; and
reading the cross temperature from the non-volatile memory in response to a message requesting the cross temperature, wherein the cross temperature is transmitted after reading the cross temperature from the non-volatile memory.
